(19) United States
(12) Patent Application Publication
(10) Pub. No.: US 2008/0164424 A1
(43) Pub. Date: Jul. 10, 2008

(54) Reducing Background Fluorescence in Arrays

(76) Inventors: Joel Myerson, Berkeley, CA (US); Bo U. Curry, Redwood City, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/555,185

(22) Filed: Jan. 10, 2007

(51) Int. Cl. G21G 5/00

(52) U.S. Cl. 250/492.1

(57) ABSTRACT

The invention relates to novel methods for reducing background fluorescence of arrays. In particular embodiments, the invention provides a method of treating an array by exposing the array to light wherein the array receives at least a specified dosage of light. In various embodiments the invention also provides a device for exposing an array to light, wherein the device includes: (a) a light source capable of producing light; and (b) an array holder configured to hold the array, the array holder disposed to permit the array to receive the light from the light source.

### FIELD OF THE INVENTION

The invention relates generally to methods of biochemical analysis. More specifically, the invention relates to providing arrays having low background fluorescence.

### BACKGROUND OF THE INVENTION

Straightforward and reliable methods for simultaneously analyzing several constituents of a complex sample are extremely desirable. Arrays (such as polynucleotide, peptide, or other biomolecule arrays) are known and are used, for example, as diagnostic or screening tools. Such arrays include regions of usually different biomolecules (“capture agents”) arranged in a predetermined configuration on a substrate. The arrays are “addressable” in that these regions (sometimes referenced as “array features”, or just “features”) have different predetermined locations (“addresses”) on the substrate of the array. The arrays typically are fabricated on planar substrates either by depositing previously obtained biomolecules onto the substrate in a site specific fashion or by site specific in situ synthesis of the biomolecules upon the substrate. After depositing the biomolecule capture agents onto the substrate, the substrate is typically processed (e.g., washed and blocked for example) and stored prior to use.

Arrays having biological or chemical capture agents immobilized on a solid surface may be employed in many kinds of assays. For instance, high-density arrays are valuable tools used by drug researchers and geneticists in a variety of binding assays, such as to obtain information on the expression of genes. Changes in gene expression may be measured in single nucleic acid polymorphism (SNP) assays using an array containing nucleic acid capture agents. Clinical and research laboratories use DNA testing to evaluate genetic risk factors for diseases like breast cancer, heart disease, Alzheimer's disease, etc. Extensive multiplexing is possible, allowing simultaneous screening for many risk factors using arrays that have many features (e.g. regions bearing DNA capture agents) onto the same substrate. A high-density array typically has between 2,000 and 50,000 capture agents (possibly up to 100,000, or more) on a single substrate. The DNA capture agents typically are single stranded DNA molecules, each of a known and different sequence, arranged in a predetermined configuration on a substrate.

In use, an array is contacted with a sample or labeled sample containing analytes (typically, but not necessarily, other biomolecules) under conditions that promote specific binding of the analytes in the sample to one or more of the capture agents present on the array. Thus, the arrays, when exposed to a sample, will undergo a binding reaction with the sample and exhibit an observed binding pattern. This binding pattern can be detected upon interrogating the array. For example, all target polynucleotides (for example, DNA) in the sample can be labeled with a suitable label (such as a fluorescent compound), and the label then can be accurately observed (such as by observing the fluorescence pattern) on the array after exposure of the array to the sample. Assuming that the different sequence polynucleotide capture agents were correctly deposited in accordance with the predetermined configuration on the array substrate, then the observed binding pattern will be indicative of the presence and/or concentration of one or more components of the sample. Techniques for scanning arrays are described, for example, in U.S. Pat. No. 5,763,870 and U.S. Pat. No. 5,945,679. Still other techniques useful for observing an array are described in U.S. Pat. No. 5,721,435.

Proper performance of an array typically depends on two basic factors: 1) retention of the immobilized capture agents on the substrate, and 2) hybridization of the target analytes to the immobilized capture agents, as measured by fluorescence emission from the fluorescently labeled target analytes. The capture agents must be retained on the surface of the substrate through a series of washing, blocking, hybridizing (specific binding to the target analytes), and rinsing operations that are commonplace in array assays, such as DNA hybridization assays. An excessive amount of background signal, or noise, from the substrate can lead to a low fluorescent-signal-to noise ratio and uncertain or erroneous results. Often during the detection step of an assay, background fluorescence from the substrate surface under certain light wavelengths can obscure or optically “wash out” the signal emitted from fluorescently labeled target analytes bound to immobilized capture agents. A high level of background fluorescence prevents the user from accurately determining a base-line level of fluorescence. Hence, assay detection and analysis may suffer.

In addition, variation of background signal across an array or from feature to feature is often not uniform. This can cause a problem with both the sensitivity and reproducibility of array results. For example, when ratios of two different color targets are simultaneously being determined (a “two-color” gene expression assay, in which fluorescence from two different fluorescent labels is measured), a variation of background fluorescence across a slide will cause poor results. In particular, if the background fluorescence of one color is significantly different than the other color, and cannot be appropriately corrected for, an inaccurate ratio determination will result. In addition, if the colors of the two targets are reversed (an operation which should not affect the actual ratios), the measured ratios may actually invert if the uncorrected fluorescence is of the same order of intensity as the measured signal.

Various methods have been proposed to address the problem of background fluorescence (also called “autofluorescence” or “contaminating fluorescence”). One such method includes treatment of array slides with sodium borohydride. See Raghavachari, et al., “Reduction of autofluorescence on DNA microarrays and slide surfaces by treatment with sodium borohydride,” Anal. Biochem. (2003) 312(2): 101-105. A second method entails exposure of the slides to air before printing and also makes use of a hyperspectral imaging scanner. See Martinez, et al., “Identification and removal of contaminating fluorescence from commercial and in-house printed DNA microarrays,” Nucleic Acids Res. (2003) 31(4): e18. None of these methods have been completely successful in solving the problem. There is a need for an effective and convenient method for decreasing or removing this fluorescence in order to maximize the sensitivity and reliability of DNA arrays.

### SUMMARY OF THE INVENTION

The invention thus relates to novel methods for reducing background fluorescence of arrays. In particular embodiments, the invention provides a method of treating an array by exposing the array to light, wherein the array receives at least a specified dosage of light in less than about 5 days, wherein the specified dosage is 1 W·H/cm². In typical embodiments, the method is observed to result in a reduction of the background fluorescence of at least 10%. In certain embodiments, the method may include collecting data on light dosage vs. response and using the data to determine the specified dosage. In certain embodiments the method includes measuring the background fluorescence over time and stopping the exposure when the background fluoresce has been reduced to a desired level (or ceases to decrease upon further treatment).

In various embodiments the invention also provides a device for exposing an array to light, wherein the device includes: (a) a light source capable of producing light; and (b) an array holder configured to hold the array, the array holder disposed to permit the array to receive the light from the light source. The light source is capable of producing light having a spectrum that includes wavelengths in the range from 340 nm to about 700 nm, wherein the light source is adapted to substantially omit light having a wavelength less than about 340 nm. In particular embodiments the light source includes a broad band light source and filter, wherein the filter attenuates light at wavelengths shorter than 340 nm and passes light having wavelengths in the 370-700 nm range. In some embodiments the light source is a narrow band light source which emits light having wavelengths in the 340-700 nm range.

Additional objects, advantages, and novel features of this invention shall be set forth in part in the descriptions and examples that follow and in part will become apparent to those skilled in the art upon examination of the following specifications or may be learned by the practice of the invention. The objects and advantages of the invention may be realized and attained by means of the instruments, combinations, compositions and methods particularly pointed out in the appended claims.

### BRIEF DESCRIPTION OF THE DRAWINGS

These and other features of the invention will be understood from the 25 description of representative embodiments of the method herein and the disclosure of illustrative apparatus for carrying out the method, taken together with the Figures, wherein

FIG. 1 schematically illustrates a device in accordance with the invention.

FIG. 2 illustrates results of a method in accordance with the invention.

Figure components are not drawn to scale.

### DETAILED DESCRIPTION

The term “nucleic acid” and “polynucleotide” are used interchangeably herein to describe a polymer of any length, e.g., greater than about 10 bases, greater than about 100 bases, greater than about 500 bases, greater than 1000 bases, usually up to about 10,000 or more bases composed of nucleotides, e.g., deoxyribonucleotides or ribonucleotides, or compounds produced synthetically (e.g., PNA as described in U.S. Pat. No. 5,948,902 and the references cited therein) which can hybridize with naturally occurring nucleic acids in a sequence specific manner analogous to that of two naturally occurring nucleic acids, e.g., can participate in Watson-Crick base pairing interactions. Naturally-occurring nucleotides typically are referenced by the name or abbreviation of the nucleobase that forms part of their structure, including guanine, cytosine, adenine, thymine, and uracil (G, C, A, T, and U, respectively).

The terms “ribonucleic acid” and “RNA” as used herein mean a polymer composed of ribonucleotides. The terms “deoxyribonucleic acid” and “DNA” as used herein mean a polymer composed of deoxyribonucleotides. The term “oligonucleotide” as used herein denotes a single stranded multimer of nucleotides of from about 2 to 100 nucleotides. Oligonucleotides are usually synthetic and, in many embodiments, are up to about 60 nucleotides in length. The term “oligomer” is used herein to indicate a chemical entity that contains a plurality of monomers. As used herein, the terms “oligomer” and “polymer” are used interchangeably, as it is generally, although not necessarily, smaller “polymers” that are prepared using the functionalized substrates of the invention, particularly in conjunction with combinatorial chemistry techniques. Examples of oligomers and polymers include polydeoxyribonucleotides (DNA), polyribonucleotides (RNA), other nucleic acids that are N- or C-glycosides of a purine or pyrimidine base, polypeptides (proteins), polysaccharides (starches, or polysugars), and other chemical entities that contain repeating units of like chemical structure.

The terms “nucleoside” and “nucleotide” are intended to include those moieties that contain not only the known purine and pyrimidine bases, but also other heterocyclic bases that have been modified. Such modifications include methylated purines or pyrimidines, acylated purines or pyrimidines, alkylated riboses or other heterocycles. In addition, the terms “nucleoside” and “nucleotide” include those moieties that contain not only conventional ribose and deoxyribose sugars, but other sugars as well. Modified nucleosides or nucleotides also include modifications on the sugar moiety, e.g., wherein one or more of the hydroxyl groups are replaced with halogen atoms or aliphatic groups, or are functionalized as ethers, amines, or the like.

The term “sample” as used herein relates to a material or mixture of materials, typically, although not necessarily, in fluid form, containing one or more components of interest.

“Background fluorescence” indicates the fluorescence measured from an array before the array has been contacted with labeled analytes from a sample. Certain embodiments of the present invention relate to reducing background fluorescence on arrays, wherein the array includes an array substrate and capture agents immobilized on the substrate.

The term “irradiance” references the radiant power incident per unit area upon a surface. Irradiance is usually expressed in watts per square centimeter

The phrase “surface-bound nucleic acid” refers to a nucleic acid that is immobilized on a surface of a solid substrate, where the substrate can have a variety of configurations, e.g., a sheet, bead, or other structure. In certain embodiments, the nucleic acid capture agents are present on a surface of the same planar support, e.g., in the form of an array.

The term “analyte” is used herein to refer to a known or unknown component of a sample. In certain embodiments of the invention, an analyte may specifically bind to a capture agent on a support surface. Typically, an “analyte” is referenced as a species in a mobile phase (e.g., fluid), to be detected by a “capture agent” which, in some embodiments, is bound to a support, or in other embodiments, is in solution. However, either of the “analyte” or “capture agent” may be the one which is to be evaluated by the other (thus, either one could be an unknown mixture of components of a sample, e.g., polynucleotides, to be evaluated by binding with the other). A “target” references an analyte. “Target polynucleotide” references a polynucletide expected to be present in a sample being analyzed; a “target polynucleotide” is a polynucleotide for which there is at least one capture agent directed to the target polynucleotide. The target polynucleotide includes a particular nucleic acid sequence of interest. Thus, the “target” can exist in the presence of other nucleic acid molecules or within a larger nucleic acid molecule. The “target”, or “target analyte” typically may be any molecule or compound of interest in a sample that is to be detected and identified via binding to a capture agent. Suitable targets include organic and inorganic molecules, biomolecules, environmental pollutants (e.g., such as pesticides, insecticides, toxins, etc.); a chemical (e.g., solvents, polymers, organic materials, etc.); a therapeutic molecule (e.g., therapeutic and abuse drugs, antibiotics, etc.); a biomolecule; whole cells (e.g., pathogenic bacteria, eukaryotic cells, etc); a virus; or spores, etc. The term “biological molecule” or “biomolecule” refers to any kind of biological entity, such as, but not limited to, oligonucleotides, DNA, RNA, peptide nucleic acid (PNA), peptides, polypeptides, protein domains, proteins, fusion proteins, antibodies, membrane proteins, lipids, lipid membranes, cellular membranes, cell lysates, oligosaccharides, polysaccharides, or lectins.

The term “capture agent” refers to an agent that binds an analyte through an interaction that is sufficient to permit the capture agent to bind and concentrate the analyte from a homogeneous mixture of different analytes. The binding interaction may be mediated by an affinity region of the capture agent. Representative capture agents include polypeptides and polynucleotides, for example antibodies, peptides, or fragments of double stranded or single-stranded DNA or RNA may employed. Capture agents usually “specifically bind” one or more analytes.

The term “substrate” or “array substrate” refers to a solid material or a semi-solid material that is porous or semi-porous, which material can form a stable support for immobilized capture agents. The substrate can be made up of a variety of materials. For instance, the materials may be organic (e.g., silanes, polylycine, hydrogels), inorganic (e.g., glass, ceramics, SiO₂, gold or platinum, or gold- or platinum-coated), polymeric (e.g., polyethylene, polystyrene, polyvinyl, polyester, etc.), or a combination of any of these, in the form of a slide, plate, film, particles, beads or spheres. Typically, the substrate surface is two dimensional and relatively flat for the printing of an array of features. The substrate may take on alternative surface configurations, e.g. the substrate may be textured with raised or depressed regions.

“Sequence” may refer to a particular sequence of bases and/or may also refer to a polynucleotide having the particular sequence of bases. Thus a sequence may be information or may refer to a molecular entity, as indicated by the context of the usage.

“Complementary” references a property of specific binding between polynucleotides based on the sequences of the polynucleotides. As used herein, polynucleotides are complementary if they bind to each other in a hybridization assay under stringent conditions, e.g. if they produce a given or detectable level of signal in a hybridization assay. Portions of polynucleotides are complementary to each other if they follow conventional base-pairing rules, e.g. A pairs with T (or U) and G pairs with C.

If a polynucleotide, e.g. a capture agent, is “directed to” a target, the polynucleotide has a sequence that is complementary to a sequence in that target and will specifically bind (e.g. hybridize) to that target under hybridization conditions. The hybridization conditions typically are selected to produce binding pairs of nucleic acids, e.g., capture agents and targets, of sufficient complementarity to provide for the desired level of specificity in the assay while being incompatible to the formation of binding pairs between binding members of insufficient complementarity to provide for the desired specificity. Such hybridization conditions are typically known in the art. Examples of such appropriate hybridization conditions are also disclosed herein for hybridization of a sample to an array.

The phrase “labeled population of nucleic acids” refers to mixture of nucleic acids that are detectably labeled, e.g., fluorescently labeled, such that the presence of the nucleic acids can be detected by assessing the presence of the label.

The term “array” encompasses the term “microarray” and refers to an ordered array presented for binding to nucleic acids and the like.

An “array,” includes any two-dimensional or substantially two-dimensional (as well as a three-dimensional) arrangement of spatially addressable regions bearing nucleic acids, particularly oligonucleotides or synthetic mimetics thereof, and the like, e.g., UNA oligonucleotides. Where the arrays are arrays of nucleic acids, the nucleic acids may be adsorbed, physisorbed, chemisorbed, or covalently attached to the arrays at any point or points along the nucleic acid chain.

Any given substrate may carry one, two, four or more arrays disposed on a surface of the substrate. Depending upon the use, any or all of the arrays may be the same or different from one another and each may contain multiple spots or features. A typical array may contain one or more, including more than two, more than ten, more than one hundred, more than one thousand, more ten thousand features, or even more than one hundred thousand features, in an area of less than 20 cm² or even less than 10 cm², e.g., less than about 5 cm², including less than about 1 cm², less than about 1 mm², e.g., 100 μm², or even smaller. For example, features may have widths (that is, diameter, for a round spot) in the range from a 10 μm to 1.0 cm. In other embodiments each feature may have a width in the range of 1.0 μm to 1.0 mm, usually 5.0 μm to 500 μm, and more usually 10 μm to 200 μm. Non-round features may have area ranges equivalent to that of circular features with the foregoing width (diameter) ranges. At least some, or all, of the features are of different compositions (for example, when any repeats of each feature composition are excluded the remaining features may account for at least 5%, 10%, 20%, 50%, 95%, 99% or 100% of the total number of features). Inter-feature areas will typically (but not essentially) be present which do not carry any nucleic acids (or other biopolymer or chemical moiety of a type of which the features are composed). Such inter-feature areas typically will be present where the arrays are formed by processes involving drop deposition of reagents but may not be present when, for example, photolithographic array fabrication processes are used. It will be appreciated though, that the inter-feature areas, when present, could be of various sizes and configurations.

Each array may cover an area of less than 200 cm², or even less than 50 cm², 5 cm², 1 cm², 0.5 cm², or 0.1 cm². In certain embodiments, the substrate carrying the one or more arrays will be shaped generally as a rectangular solid (although other shapes are possible), having a length of more than 4 mm and less than 150 mm, usually more than 4 mm and less than 80 mm, more usually less than 20 mm; a width of more than 4 mm and less than 150 mm, usually less than 80 mm and more usually less than 20 mm; and a thickness of more than 0.01 mm and less than 5.0 mm, usually more than 0.1 mm and less than 2 mm and more usually more than 0.2 and less than 1.5 mm, such as more than about 0.8 mm and less than about 1.2 mm. With arrays that are read by detecting fluorescence, the substrate may be of a material that emits low fluorescence upon illumination with the excitation light. Additionally in this situation, the substrate may be relatively transparent to reduce the absorption of the incident illuminating laser light and subsequent heating if the focused laser beam travels too slowly over a region. For example, the substrate may transmit at least 20%, or 50% (or even at least 70%, 90%, or 95%), of the illuminating light incident on the front as may be measured across the entire integrated spectrum of such illuminating light or alternatively at 532 nm or 633 nm.

Arrays can be fabricated using drop deposition from pulse-jets of either precursor units (such as nucleotide or amino acid monomers) in the case of in situ fabrication, or the previously obtained nucleic acid. Such methods are described in detail in, for example, the previously cited references including U.S. Pat. No. 6,242,266, U.S. Pat. No. 6,232,072, U.S. Pat. No. 6,180,351, U.S. Pat. No. 6,171,797, U.S. Pat. No. 6,323,043, U.S. patent application Ser. No. 09/302,898 filed Apr. 30, 1999 by Caren et al., and the references cited therein. As already mentioned, these references are incorporated herein by reference. Other drop deposition methods can be used for fabrication, as previously described herein. Also, instead of drop deposition methods, photolithographic array fabrication methods may be used. Inter-feature areas need not be present particularly when the arrays are made by photolithographic methods as described in those patents.

An array is “addressable” when it has multiple regions of different moieties (e.g., different oligonucleotide sequences) such that a region (i.e., a “feature” or “spot” of the array) at a particular predetermined location (i.e., an “address”) on the array will detect a particular sequence. Array features are typically, but need not be, separated by intervening spaces. In the case of an array in the context of the present application, the “population of labeled nucleic acids” or “labeled sample” and the like will be referenced as a moiety in a mobile phase (typically fluid), to be detected by “surface-bound nucleic acids” which are bound to the substrate at the various regions.

An “array layout” refers to one or more characteristics of the features, such as feature positioning on the substrate, one or more feature dimensions, and an indication of a moiety at a given location. “Hybridizing” and “binding”, with respect to nucleic acids, are used interchangeably.

The term “stringent assay conditions” as used herein refers to conditions that are compatible to produce binding pairs of nucleic acids, e.g., probes and targets, of sufficient complementarity to provide for the desired level of specificity in the assay while being incompatible to the formation of binding pairs between binding members of insufficient complementarity to provide for the desired specificity. The term stringent assay conditions refers to the combination of hybridization and wash conditions.

A “stringent hybridization” and “stringent hybridization wash conditions” in the context of nucleic acid hybridization (e.g., as in array, Southern or Northern hybridizations) are sequence dependent, and are different under different experimental parameters. Exemplary stringent hybridization conditions that can be used to identify nucleic acids within the scope of the invention can include, e.g., hybridization in a buffer comprising 50% formamide, 5×SSC, and 1% SDS at 42° C., or hybridization in a buffer comprising 5×SSC and 1% SDS at 65° C., both with a wash of 0.2×SSC and 0.1% SDS at 65° C. Hybridization buffers suitable for use in the methods described herein are well known in the art and may contain salt, buffer, detergent, chelating agents and other components at pre-determined concentrations.

The term “mixture”, as used herein, refers to a combination of elements, that are interspersed and not in any particular order. A mixture is heterogeneous and not spatially separable into its different constituents. Examples of mixtures of elements include a number of different elements that are dissolved in the same aqueous solution, or a number of different elements attached to a solid support at random or in no particular order in which the different elements are not specially distinct. In other words, a mixture is not addressable. To be specific, an array of surface-bound oligonucleotides, as is commonly known in the art and described below, is not a mixture of surface-bound oligonucleotides because the species of surface-bound oligonucleotides are spatially distinct and the array is addressable.

“Isolated” or “purified” generally refers to isolation of a substance (compound, polynucleotide, protein, polypeptide, polypeptide composition) such that the substance comprises a significant percent (e.g., greater than 1%, greater than 2%, greater than 5%, greater than 10%, greater than 20%, greater than 50%, or more, usually up to about 90%-100%) of the sample in which it resides. In certain embodiments, a substantially purified component comprises at least 50%, 80%-85%, or 90-95% of the sample. Techniques for purifying polynucleotides and polypeptides of interest are well-known in the art and include, for example, ion-exchange chromatography, affinity chromatography and sedimentation according to density. Generally, a substance is purified when it exists in a sample in an amount, relative to other components of the sample, that is not found naturally.

The terms “determining”, “measuring”, “evaluating”, “assessing” and “assaying” are used interchangeably herein to refer to any form of measurement, and include determining if an element is present or not. These terms include both quantitative and/or qualitative determinations. Assessing may be relative or absolute. “Assessing the presence of” includes determining the amount of something present, as well as determining whether it is present or absent.

The term “using” has its conventional meaning, and, as such, means employing, e.g., putting into service, a method or composition to attain an end. For example, if a program is used to create a file, a program is executed to make a file, the file usually being the output of the program. In another example, if a computer file is used, it is usually accessed, read, and the information stored in the file employed to attain an end. Similarly if a unique identifier, e.g., a barcode is used, the unique identifier is usually read to identify, for example, an object or file associated with the unique identifier.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Where a range of values is provided, it is understood that each intervening value, to the tenth of the unit of the lower limit unless the context clearly dictates otherwise, between the upper and lower limit of that range and any other stated or intervening value in that stated range is encompassed within the invention.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

Accordingly, in typical embodiments the invention provides a method of treating an array, the method comprising exposing the array to light, wherein the array receives at least a specified dosage of light in less than about 5 days, wherein the specified dosage is 1 W·H/cm². In particular embodiments, the specified dosage is selected from 2 W·H/cm², 5 W·H/cm², 10 W·H/cm², 20 W·H/cm², 50 W·H/cm², or 100 W·H/cm². In various embodiments, the array receives the specified dosage in less than about 2 days, less than about 24 hours, less than about 12 hours, or less than about 6 hours.

The dosage received by the array may be determined by integrating the irradiance over time, or equivalent measurement, e.g. multiplying the average irradiance during a time period by the duration of the time period. The irradiance is measured at the surface of the array, e.g. using a standard light meter adapted to measure irradiance.

The array typically includes a plurality of capture agents immobilized on a substrate. Representative capture agents include polypeptides and polynucleotides, for example antibodies, peptides, or fragments of double stranded or single-stranded DNA or RNA may employed. The substrate can be made up of a variety of materials that form a stable support for the immobilized capture agents. For example, the substrate may include organic materials, inorganic materials, polymeric materials, or a combination of any of these, in the form of a slide, plate, film, particles, beads or spheres. The substrate may take on alternative surface configurations, e.g. the substrate may be textured with raised or depressed regions. In typical embodiments the capture agents are polynucleotides, e.g. the array is a DNA array or an RNA array. In certain embodiments, the substrate comprises glass, e.g. is a planar piece of glass.

The method includes exposing the array to light. In some embodiments the capture agents of the array are biomolecules that may be adversely affected by intense, energetic light (e.g. polynucleotides are known to be sensitive to cross-linking reactions upon exposure to UV light); thus, in typical embodiments the light to which the array is exposed substantially omits light at in the UV spectrum (e.g. from 200 nm to 400 nm), e.g. wavelengths shorter than 340 nm. In this regard, “substantially omits” means that the irradiance of the light (measured at the array surface) in the spectral interval from 200 nm to 340 nm is less than 1% (e.g. less than 0.5%, less than 0.1%, or less than 0.01%) of the irradiance of the light in the spectral interval from 200 nm to 700 nm. The indicated percentage is thus calculated as (irradiance in the wavelength range from 200-340 m) divided by (the irradiance in the wavelength range from 200-700 nm), multiplied by 100%. A “spectral interval” is a continuous range of wavelengths in the indicated range, e.g. a spectral interval from 200 nm to 340 nm references a continuous range of wavelengths from 200 nm to 340 nm.

The light may be broad spectrum light (i.e. exhibiting substantial spectral irradiance over a spectral interval of at least 100 nm, e.g. at least 200 nm) or may be narrow spectrum light (i.e. any substantial spectral irradiance of which is confined to a spectral interval of less than 50 nm, e.g. less than 20 nm). The light may be from any available source that provides light having the characteristics described herein. The light source is capable of providing the specified dosage in the indicated period of time. In particular embodiments, the light is from a light source that includes a narrow band source, e.g. a light emitting diode, laser diode, or laser. In some embodiments, the light is from a light source that includes a broad band source, e.g. a tungsten lamp, a tungsten halogen lamp, or a zenon lamp, or other broad band source. In typical embodiments in which the light is from a light source that includes a broad band source, the light is passed through a filter that attenuates light in the ultraviolet (UV) range (e.g. less than about 400 nm, e.g. less than about 340 nm) before the array is exposed to the light. In some embodiments in which the light is from a light source that includes a broad band source, the light is passed through a filter that attenuates light in the infrared (IR) range (e.g. greater than about 700 nm) before the array is exposed to the light. In typical embodiments, substantially all of the light from the light source directed at the array is in the range from about 340 nm to about 700 nm.

In some embodiments, prior to exposing the array to the light, the method of the present invention further includes collecting data on light dosage versus response (e.g. response may be measured as decrease in fluorescence or rate of decrease in fluorescence), for example in test runs or qualification runs of the method. The collected data is then used to determine the specified dosage in the processing of further arrays.

The specified dosage may be determined in any effective manner based on the desired amount of fluorescence reduction and other parameters, such as the time and light source available. Exemplary ways to determine the specified dosage include, but are not limited to, e.g. collecting data on light dosage versus response, the data may then be plotted to determine a time or dosage deemed sufficient to provide the specified dosage. The data may be fit to a rate equation to determine a rate constant or a half life, and then set the specified dosage to a value corresponding to at least 3 half lives, e.g. 5 or 10 half lives). The specified dosage may also be determined by using empirical methods to determine the dosage required provide a desired amount of reduction in background fluorescence, e.g. a reduction in background fluorescence of at least 10%, at least 20%, at least 30%, at least 40%, or more. In certain embodiments, the method results in a reduction in background fluorescence of at least 10%, at least 20%, at least 30%, at least 40%, at least 50%, at least 75%, or more. Typically, there often is observed a gradient of background fluorescence across an array, i.e. there is an observable shift in the amount of background fluorescence from one portion of the array to another (e.g. from the center of the array to the edge of the array. In typical embodiments in which there is a gradient of background fluorescence across an array, the method of the present invention is observed to reduce the magnitude of the gradient of background fluorescence.

To determine light dosage versus response, background fluorescence is measured on a set of arrays exposed to varying dosage of light e.g. varying the time (duration) of exposure of a set of arrays (e.g. 20 min., 1 hr, 3 hrs, 9 hrs, 27 hrs, 81 hrs) under a given set of conditions (e.g. light source, temp, gaseous environment, array characteristics). As a first rough determination, the initial background fluorescence of a single array may be measured, then the array is exposed to light for a period of time. Then, the background fluorescence is re-measured, and the array is re-exposed to light for a period of time. Then, the background fluorescence is again re-measured, and the array is again re-exposed to light for a period of time. These steps may be repeated numerous times to collect expose the array to light again for another period of time, again re-measure fluorescence, etc. This method allows a rough determination of the dosage response under the given set of conditions to establish the specified dosage. In certain embodiments the method includes measuring the background fluorescence over time and stopping the exposure when the background fluorescence has been reduced to a desired level (or ceases to decrease upon further treatment). Typically, under a given set of conditions (e.g. light source, temp, gaseous environment, array characteristics), the specified dosage will correspond to a measure of time (duration for the array to be exposed to the light).

In particular embodiments, exposing the array to light is performed under conditions which include contacting the array with a gas having at least about 20% relative humidity, e.g. at least about 30% relative humidity, at least 40%, relative humidity, or at least 50% relative humidity. Also, in some embodiments, the conditions include a temperature in the range from about −20° C. to about 80° C., e.g. from about −10° C.

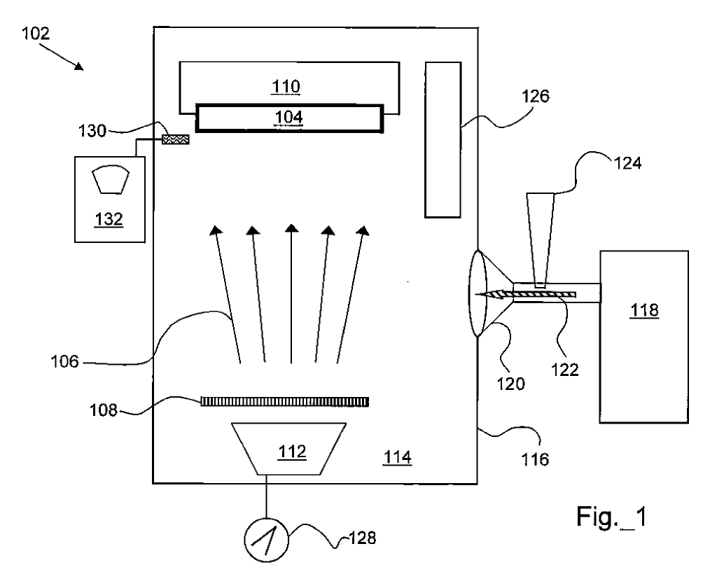

With reference to FIG. 1, in various embodiments the invention also provides a device 102 for exposing an array 104 to light (indicated by arrows 106), wherein the device 102 includes: (a) a light source 112 operable to produce light 106; and (b) an array holder 110 configured to hold the array 104, the array holder 110 disposed to permit the array 104to receive the light 106 from the light source 112. The light source 112 is operable to produce light having a spectrum that includes wavelengths in the range from 340 nm to about 700 nm, wherein the light source is adapted to substantially omit light having a wavelength less than about 340 nm. In particular embodiments the light source includes a broad band light source and filter 108, wherein the filter attenuates light at wavelengths shorter than 340 nm and passes light having wavelengths in the 360-700 nm range. In some embodiments the light source is a narrow band light source which emits light having wavelengths in the 340-700 nm range.

In typical embodiments, the device 102 for exposing the array 104 to light 106 also includes a housing 116 defining a chamber 114, the array holder 110 disposed in the chamber 114, the housing 116 having a gas inlet 120 in fluid communication with the chamber 114. The gas inlet 120 is operable to receive a gas (indicated by arrow 122) from a gas source 118 and deliver the gas 122 into the chamber 114. In some embodiments, the device 102 includes a gas source 118 in fluid communication with the gas inlet 120. In particular embodiments, the gas 122 may be an inert gas, an atmospheric gas, or other gas. In certain embodiments, the gas source 118 provides a gas 122 having a relative humidity of at least 20%, e.g. at least 30%, at least 40%, at least 50%. In certain embodiments, the device includes a humidifier component 124 in fluidic communication with the chamber 114. The humidifier component typically comprises one or more components selected from a bubbler, a nebulizer, a spray chamber, an atomizer, a hot water bath, or any other component adapted to increase the relative humidity in the chamber 114.

In some embodiments, a cooling element 126 is disposed in or adjacent the housing 116. The cooling element 126 is operable to cool the chamber 114 and elements disposed in the chamber 114, such as the light source 112, the array holder 110, the array 104. The cooling element may include any kind of cooling apparatus, such as a fan, a gas inlet for cool gas, a heat sink, a cold block, a hollow heat sink plumbed to circulate coolant (e.g. from a cold water bath), or the like.

In certain embodiments the device 102 includes a timer 128 in operable relation to the light source 112, the timer capable of switching off the light source 112 after a designated time period.

In some embodiments the device 102 includes light sensor 130 disposed to receive light from the light source 112; typically the light sensor 130 is disposed adjacent the array holder 110 and is proximal to the array 104. In some embodiments, the light sensor is in electrical communication with a light dosage meter 132, wherein the light dosage meter is operable to measure the dosage of light in the immediate vicinity of the surface of the array 104.

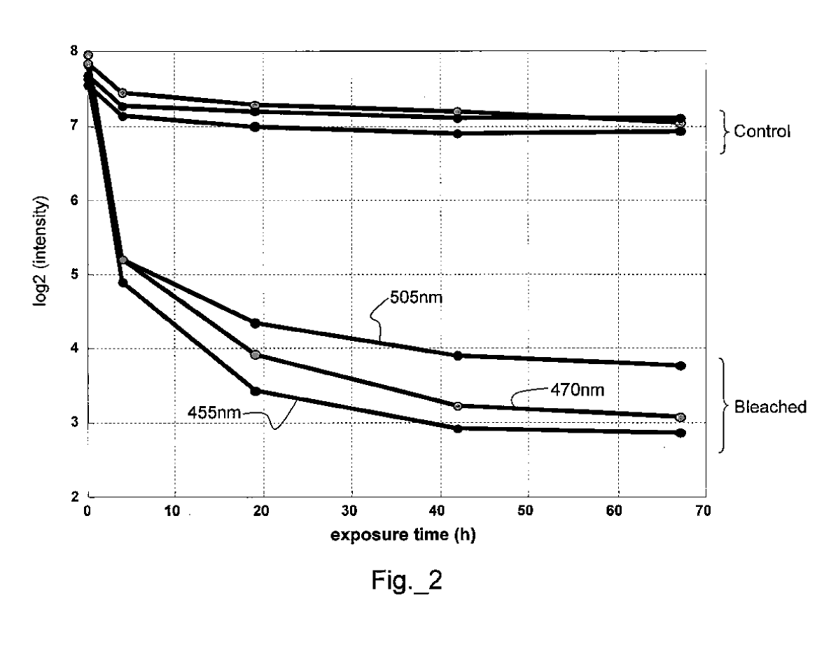

Accordingly, in particular embodiments, the method of exposing the array to light as disclosed herein results in a decrease in background fluorescence. This is illustrated in FIG. 2, which shows results from conducting an experiment in accordance with the present invention. FIG. 2 shows the rate of photobleaching over time using 1 watt LEDs of three different wavelengths to illuminate an array. In an enclosed chamber, the three LEDs were placed directly adjacent to a single array substrate containing a large array, and were spatially separated to expose different areas of the array to different wavelengths of light. A separate control array was placed in the same chamber but not exposed to the LEDs. The arrays were removed for fluorescence analysis using an Agilent array scanner at time points from zero to about 68 hours. The degree of bleaching in the region of each LED is shown by the set of three lines labeled “bleached”. The wavelengths of the three LEDs were 455 nm (royal blue), 470 nm (blue), and 505 (cyan). The results for the same regions of the array in the control array not exposed to the LEDs are shown by the set of three lines labeled “control”.

Under these conditions, substantial bleaching occurred after 5 hours, and bleaching largely leveled off by about 40 hours. All of the LEDs caused significant bleaching, but the shorter wavelength LEDs were more effective. (In data not shown, a 590 nm LED (amber) resulted in a significantly slower rate of bleaching). The control arrays showed a slight drop in signal, which may have been due to the effect of heat, air, or moisture.

The practice of the present invention will employ, unless otherwise indicated, conventional techniques of synthetic organic chemistry, biochemistry, molecular biology, and the like, which are within the skill of the art. Such techniques are explained fully in the literature. This description puts forth how to perform the methods and use the compositions disclosed and claimed herein. Efforts have been made to ensure accuracy with respect to numbers (e.g., amounts, temperature, etc.) but some errors and deviations should be accounted for. Unless indicated otherwise, parts are parts by weight, temperature is in ° C. and pressure is at or near atmospheric. Standard temperature and pressure are defined as 20° C. and 1 atmosphere.

While the foregoing embodiments of the invention have been set forth in considerable detail for the purpose of making a complete disclosure of the invention, it will be apparent to those of skill in the art that numerous changes may be made in such details without departing from the spirit and the principles of the invention. Accordingly, the invention should be limited only by the following claims.

All patents, patent applications, and publications mentioned herein are hereby incorporated by reference in their entireties, provided that if there is a conflict in definitions the definitions explicitly set forth herein shall control.

What is claimed is:

1. A method of treating an array comprising exposing the array to light, wherein the array receives at least a specified dosage of light in less than about 5 days, wherein the specified dosage is 1 W·H/cm².

2. The method of claim 1, wherein the array receives at least the specified dosage in less than about 2 days.

3. The method of claim 1, wherein the array receives the specified dosage in less than about 24 hours.

4. The method of claim 1, wherein the array receives the specified dosage in less than about 12 hours.

5. The method of claim 1, wherein the light substantially omits light of a wavelength shorter than about 340 nm.

6. The method of claim 1, wherein the light is from a light source that includes a narrow band source.

7. The method of claim 1, wherein the light is from a light source that includes a broad band source and a filter that attenuates light in the UV range.

8. The method of claim 7, wherein the light source further includes a filter that attenuates light in the IR range.

9. The method of claim 1, further comprising prior to exposing the array, collecting date on light dosage versus response and using the data to determine the specified dosage.

10. The method of claim 1, wherein the exposing the array is performed under conditions which include contacting the array with a gas having at least about 20% relative humidity.

11. The method of claim 10, wherein the gas has at least about 50% relative humidity.

12. The method of claim 1, wherein exposing the array is performed under conditions including a temperature in the range from about −20° C. to about 80° C.

13. A device for exposing an array to light, the device comprising:
a light source, the light source operable to produce light having a spectrum that includes wavelengths in the range from 340 nm to about 700 nm, wherein the light source is adapted to substantially omit light having a wavelength less than about 340 nm;
an array holder configured to hold the array, the array holder disposed to permit the array to receive light from the light source.

14. The device of claim 13, further comprising a housing defining a chamber, the array holder disposed in the chamber, the housing having a gas inlet in fluid communication with the chamber.

15. The device of claim 14, further comprising a means for introducing moisture into a gas, said means in operable relation to the gas inlet.

16. The device of claim 14, further comprising a gas source in fluid communication with the gas inlet.

17. The device of claim 13, further comprising a housing defining a chamber, the array holder disposed in the chamber, the housing having a cooling element operable to cool the chamber (e.g. fan, gas inlet for cool gas, heat sink, cold block, a hollow heat sink plumbed to circulated coolant (e.g. from in water bath)

18. The device of claim 13, further comprising a timer in operable relation to the light source, the timer capable of switching off the light source after a designated time period.

19. The device of claim 13, further comprising a light sensor disposed to receive light from the light source and a light dosage meter in electrical communication with the light sensor.

20. The device of claim 13, wherein the light source includes a filter capable of attenuating light in the UV range but passing light in the 350 to 700 nm range.
